(19) United States
(12) Patent Application Publication
(10) Pub. No.: US 2020/0020051 A1
(43) Pub. Date: Jan. 16, 2020

(54) SYSTEMS AND METHODS FOR OPERATING A SERVICE TO MONITOR AND ADJUST A BOOKED FLIGHT

(71) Applicant: CAPITAL ONE SERVICES, LLC, McLean, VA (US)

(72) Inventors: Joshua EDWARDS, Philadelphia, PA (US); Carrie NORMAN, Frisco, TX (US); Abdelkader M'Hamed BENKREIRA, Washington, DC (US)

(73) Assignee: CAPITAL ONE SERVICES, LLC

(21) Appl. No.: 16/033,164

(22) Filed: Jul. 11, 2018

(51) Int. Cl. G06Q 50/14; G06Q 10/02; G06Q 20/40

(52) U.S. Cl. CPC G06Q 50/14; G06Q 20/407; G06Q 10/02

(57) ABSTRACT

A computer-implemented method for servicing a user's flight includes monitoring activities that occur at a server or the user device associated with the user. The method also includes identifying a transaction of the user and detecting a booked flight associated with the transaction. The method further includes obtaining a confirmation code associated with the booked flight and monitoring price information associated with the booked flight. The method also includes automatically submitting to an airline service provider a request for adjusting the booked flight according to a result of the determination that the condition for flight adjustment is met based on the monitored price information.

### TECHNICAL FIELD

The present disclosure relates to systems and methods for servicing a user's flight, and more particular, to a process for monitoring and adjusting a booked flight on the user's behalf.

### BACKGROUND

To maximize revenue, modern airlines price air fares dynamically and in real time using big data and sophisticated software. Airlines consider various factors to predict demand and set prices accordingly. To travelers, however, pricing seems pretty random, and searching for a good deal on airfare can become frustrating. It is therefore difficult for regular users to predict when is the best time to book a flight. Many travelers book a flight relatively early, hoping booking early would be cheaper, which may not be true. A traveler who purchased a ticket several months in advance may find out that a passenger next to him or her purchased their ticket just a week ago for hundreds of dollars less. On the other hand, some travelers may wait for a better deal and suddenly find out all seats are sold out, or the ticket can be purchased only at a much higher price.

Accordingly, it may be desirable to provide improved systems and methods for automatically searching for a better deal after a user has booked a flight.

### SUMMARY

One aspect of the present disclosure is direct to a computer-implemented system for servicing a user's flight based on transaction information, including at least one storage device storing instructions and at least one processor, when executing the instructions, configured to cause the system to perform a method including monitoring online activities associated with a user that occur at a server or a user device associated with the user. The method also includes identifying a transaction of the user according to the monitored online activities; obtaining information relating to the transaction; detecting a booked flight associated with the user according to information of the transaction; determining whether the information of the transaction includes a confirmation code associated with the booked flight, the confirmation code being a unique identifier of a purchased airline ticket of the booked flight; causing, based on a result of the determination that the transaction information does not include a confirmation code, the user device to display a user interface for entering a confirmation code; obtaining a confirmation code associated with the booked flight based on an input by the user received in the user interface at the user device; monitoring price information associated with the booked flight; determining, based on the monitored price information associated with the booked flight, whether a condition for flight adjustment is met; and submitting, to an airline service provider, a request for adjusting the booked flight based on a result of the determination that the condition for flight adjustment is met, where the request for adjusting the booked flight include the confirmation code.

Another aspect of the present disclosure is direct to a computer-implemented method for servicing a user's flight based on enhanced flight transaction information, the method including monitoring an email account of a user; parsing an email received by the user device to generate data fields and identifying a transaction of the user according to the generated data fields; obtaining information relating to the transaction; detecting a booked flight associated with the user according to information of the transaction; determining whether the information of the transaction includes a confirmation code associated with the booked flight, the confirmation code being a unique identifier of a purchased airline ticket of the booked flight; causing, based on a result of the determination that the transaction information does not include a confirmation code, the user device to display a user interface for entering a confirmation code; obtaining a confirmation code associated with the booked flight based on an input by the user received in the user interface at the user device; transmitting, to a price monitoring server, a request for monitoring price information associated with the booked flight, the request for monitoring price information associated with the booked flight including the confirmation code; receiving, from the price monitoring server, price information associated with the booked flight and determining, based on the received price information associated with the booked flight, whether a condition for flight adjustment is met; and submitting, to an airline service provider, a request for adjusting the booked flight based on a result of the determination that the condition for flight adjustment is met, the request for adjusting the booked flight including the confirmation code.

Yet another aspect of the present disclosure is directed to a non-transitory computer-readable medium storing instructions executable by a processor to perform a method for servicing a user's flight based on enhanced flight transaction information. The method includes monitoring online activities associated with a user that occur at a server or a user device associated with the user; identifying a transaction of the user according to the monitored online activities; obtaining information relating to the transaction; detecting a booked flight associated with the user according to information of the transaction; determining whether the information of the transaction includes a confirmation code associated with the booked flight, the confirmation code being a unique identifier of a purchased airline ticket of the booked flight; causing, based on a result of the determination that the transaction information does not include a confirmation code, the user device to display a user interface for entering a confirmation code; obtaining a confirmation code associated with the booked flight based on an input by the user received in the user interface at the user device; transmitting, to a price monitoring server, a request for monitoring price information associated with the booked flight, the request for monitoring price information associated with the booked flight including the confirmation code; receiving, from the price monitoring server, price information associated with the booked flight; determining, based on the received price information associated with the booked flight, whether a condition for flight adjustment is met; and submitting, to an airline service provider, a request for adjusting the booked flight based on a result of the determination that the condition for flight adjustment is met, the request for adjusting the booked flight including the confirmation code.

Aspects of disclosed embodiments may include tangible computer-readable media that store software instructions that, when executed by one or more processors, are configured to perform and execute one or more of the methods, operations, or the like consistent with the disclosed embodiments. Also, aspects of the disclosed embodiments may be performed by one or more processors that are configured as a special-purpose processor based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a block diagram of an exemplary computing device, consistent with disclosed embodiments.

FIG. 3 is a block diagram of an exemplary automation engine for servicing a user's flight, consistent with disclosed embodiments.

FIG. 4 is a flowchart of an exemplary process of automatically adjusting a booked flight for a user, consistent with disclosed embodiments.

FIG. 5 is a flowchart of an exemplary process of detecting a booked flight based on information relating to a transaction, consistent with disclosed embodiments.

FIG. 6 is a flowchart of an exemplary process of monitoring price information associated with a booked flight, consistent with disclosed embodiments.

FIG. 7 is a flowchart of an exemplary process of automating an action for adjusting a booked flight, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

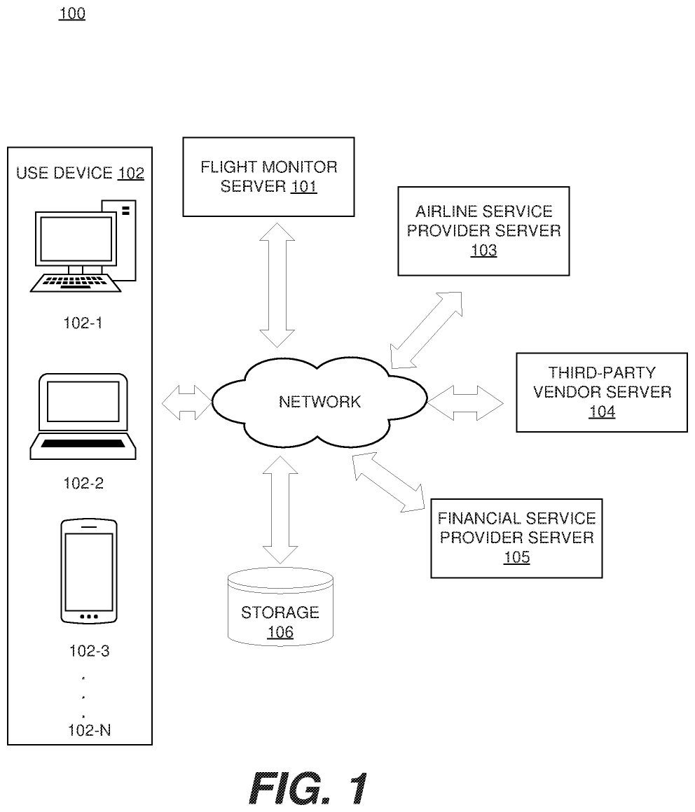

FIG. 1 is a block diagram of an exemplary system 100 for performing one or more operations, consistent with the disclosed embodiments. Components of system 100 may comprise computing systems configured to provide systems and methods that automatically monitor for price change of one or more flights for a user after the user has booked a flight (which is also referred to as a booked flight in this disclosure). Disclosed systems and methods may also automate a process of adjusting the booked flight on the user's behalf if a current price drops below a threshold. For example, the systems and methods may automatically cancel the booked flight and rebook the flight without the user's intervention. Without the aid of the systems and methods disclosed in this application, the user may need to manually check the price frequently to determine if a lower price is available, and may miss the opportunity to rebook at the lower price because the time window to rebook has closed. Also, even if the user is able to find a lower price, the user may have to manually prepare a claim for a refund or cancel and rebook the flight, which can be tedious. Alternatively, a user may believe it is not worth the effort or trouble to act on the lower price information and instead take no action, leaving any potential gain unclaimed. The disclosed systems and methods may relieve a user from the tedious, time-consuming work of finding a lower price after booking a flight. Disclosed systems and methods may further free the user from the need to act to gain certain benefits. The systems and methods act on the user's behalf to obtain post-booking remedies without significant effort by the user by automatically filing a claim to change the flight if a lower price is available. The systems and methods may also provide an improved user interface allowing the user to interact with the systems more efficiently during the process.

With reference to FIG. 1, in one embodiment, system 100 includes one or more flight monitor servers 101, one or more user devices 102, one or more airline service provider servers 103, one or more third-party vendor servers 104, one or more financial service provider servers 105, one or more storages 106, and a network 107. Consistent with disclosed embodiments, a user may be associated with one or more user devices 102. The components and arrangement of the components included in system 100 may vary. Thus, system 100 may include other components that perform or assist in the performance of one or more processes consistent with the disclosed embodiments.

As further described herein, components of system 100 may include one or more computing devices (e.g., computer(s), server(s), etc.), memory storing data and/or software instructions (e.g., database(s), memory device(s), etc.), and other known computing components. In some embodiments, the one or more computing devices may be configured to execute software instructions stored on one or more memory devices to perform one or more operations consistent with the disclosed embodiments. Components of system 100 may be configured to communicate with one or more other components of system 100, including systems associated with flight monitor server 101, user device 102, airline service provider server 103, third-party vendor server 104, financial service provider server 105, or Storages 106. In certain aspects, users may operate one or more components of system 100 to initiate and provide input for one or more operations consistent with the disclosed embodiments.

Flight monitor server 101 is configured to automatically monitor a user's online activities at a user device (e.g., a user device 102) associated with the user without the user's input and/or intervention. Flight monitor server 101 may also identify one or more transactions according to the activities of the user. Flight monitor server 101 may further detect one or more booked flights according to the identified transaction(s). The term “booked flight” as used herein refers to a flight for which a user has purchased an airline ticket and that has been confirmed by the airline as opposed to an “unbooked” flight that has not been confirmed. The user may purchase the airline ticket using money (e.g., through a credit card, debit card, or other types of payment methods), airline credit, rewards points, or a combination thereof. A booked flight usually has a confirmation code generated by the airline, which may be a unique code representing the airline ticket purchased by the user.

Flight monitor server 101 is also configured to monitor price information associated with the booked flight. In this regard, flight monitor server 101 may determine whether a condition for adjusting the booked flight is met according to the monitored price information. If the condition is met, flight monitor server 101 may automate a process of adjusting the booked flight on the user's behalf. For example, flight monitor server 101 may automatically cancel the booked flight and rebook the same flight on the user's behalf.

User device 102 may include one or more computing devices configured to perform one or more operations consistent with disclosed embodiments. For example, user device 102 may monitor the user's online activities. By way of example, user device 102 may use a background process to monitor emails received and/or sent by an email application installed in user device 102. In some embodiments, user device 102 may identify one or more transactions according to the monitored activities and detect one or more booked flights based on the identified transaction(s). User device 102 may also transmit a request for monitoring price information associated with the booked flight to flight monitor server 101. In response, flight monitor server 101 may monitor price information associated with the booked flight and transmit relevant price information to user device 102. User device 102 (or flight monitor server 101) may determine whether a condition for adjusting the booked flight is met based on the monitored price information and, if the condition is met, user device 102 (or flight monitor server 101) may automatically execute a process of adjusting the booked flight on the user's behalf.

In some embodiments, in addition or alternative to monitoring the user's activities by user device 102, flight monitor server 101 may monitor online activities associated with the user that occur at a server (e.g., through one or more online accounts of the user hosted by a server). For example, flight monitor server 101 may monitor an email account of the user hosted by a third-party email server (or hosted by flight monitor server 101). Flight monitor server 101 may access information relating to emails in the email account using the credentials previously provided by the user. For instance, the user may provide the username and password of the email account to flight monitor server 101. Flight monitor server 101 may then use the credential information to log into the email account or request the email server to provide certain information (e.g., transaction information). Alternatively or additionally, the user (or the email server after receiving the approval from the user) may transmit an access token (e.g., an OAuth token) to flight monitor server 101, and flight monitor server 101 may use the token to access the information relating to emails in the email account hosted by the email server.

User device 102 may include one or more user devices 102-1, 102-2, 102-3, . . . , 102-N, such as a desktop computer, laptop, server, mobile device (e.g., tablet, smartphone), or any other type of computing devices. For exemplary purposes, aspects of the disclosed embodiments are described with reference to user device 102 as a mobile client device, such as a smartphone, tablet, or the like. As mentioned herein, however, the disclosed embodiments are not limited to such examples. For example, user device 102 could be a laptop, a desktop, or any other device.

User device 102 may include one or more processors configured to execute software instructions stored in memory, such as a memory included in user device 102. User device 102 may include software that when executed by a processor performs known Internet-related communication, content display processes, and/or disclosed token vault processes for a user of user device 102. User device 102 may be a mobile device that executes mobile device applications and/or mobile device communication software that allows user device 102 to communicate with components over network 107 and generates and displays content in interfaces via a display device included in user device 102. The disclosed embodiments are not limited to any particular configuration of user device 102. For instance, user device 102 may be a mobile device that stores and executes mobile applications that provide functions offered by flight monitor server 101 and/or financial service-related functions offered by financial service provider server 105.

Airline service provider server 103 may be configured to provide users with reservation service of flights operated by an airline. A user may purchase an airline ticket from a website or application operated by airline service provider server 103. Airline service provider server 103 may also publish current prices of one or more flights on the website or application.

Third-party vendor server 104 may also provide a reservation service for flights to users and be hosted by a third-party vendor rather than an airline. A user may purchase an airline ticket through a website or application that third-party vendor server 104 operates. Third-party vendor server 104 may also publish current prices of one or more flights on the website or application.

Financial service provider server 105 may be owned and operated by a financial service provider. A financial service provider may be an entity that provides, maintains, manages, or otherwise offers financial services. For example, the financial service provider may be a bank, credit card issuer, or any other type of financial service entity that generates, provides, manages, and/or maintains financial service accounts for one or more cardholders. Financial service accounts may include, for example, credit card accounts, loan accounts, checking accounts, savings accounts, reward or loyalty program accounts, and/or any other type of financial service account known to those skilled in the art. Financial service provider includes infrastructure and components that are configured to generate and/or provide financial service accounts such as credit card accounts, checking accounts, debit card accounts, loyalty or reward programs, lines of credit, or the like.

For example, a financial service provider may include one or more Financial Service Provider Servers 105. In one aspect, Financial Service Provider Servers 105 may be one or more computing devices configured to perform one or more operations consistent with disclosed embodiments. In one aspect, Financial Service Provider Servers 105 may be a desktop computer, a server, or any other type of computing device. Financial Service Provider Servers 105 may include one or more processors configured to execute software instructions stored in memory. The one or more processors may be configured to execute software instructions that when executed by a processor performs known Internet-related communication and financial service-based processes.

Storage 106 may be configured to store information and for access and/or management by flight monitor server 101, user device 102, airline service provider server 103, third-party vendor server 104, and/or financial service provider server 105. By way of example, storage 106 may include one or more of Oracle™ databases, Sybase™ databases, or other relational databases or non-relational databases, such as Hadoop sequence files, HBase, or Cassandra. The databases or other files may include, for example, data and information related to financial records, purchase transaction data, etc. Systems and methods of disclosed embodiments, however, are not limited to separate databases.

Network 107 may be configured to facilitate communications between components of system 100. For example, flight monitor server 101 may transmit a request for adjusting a booked flight to a user of user device 102 via network 107. User device 102 may transmit a response of the user to flight monitor server 101 via network 107. Network 107 may be any type of network configured to provide communications between components of system 100. For example, network 107 may be any type of network (including infrastructure) that provides communications, exchanges information, and/or facilitates the exchange of information, such as the Internet, a Local Area Network, wireless network (e.g., a Wi-Fi/802.11 network), NFC, magnetic fields, optical code scanner, infrared, or other suitable connection(s) that enables the sending and receiving of information between the components of system 100. In other embodiments, one or more components of system 100 may communicate directly through a dedicated communication link(s) (not shown).

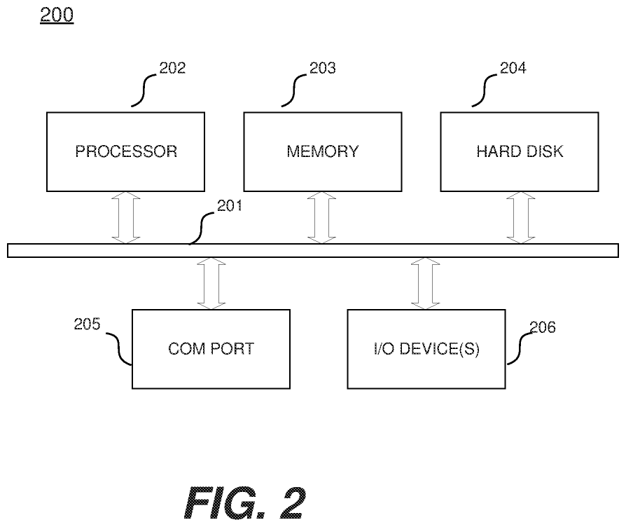

FIG. 2 is a block diagram of an exemplary computing device, consistent with disclosed embodiments. Variations of exemplary computing device 200 may be implemented as by flight monitor server 101, user device 102, airline service provider server 103, third-party vendor server 104, and/or financial service provider server 105.

In one embodiment, computing device 200 may comprise an internal communication bus 201, one or more processors 202, one or more Memories 203, one or more hard disks 204, one or more communication ports 205, and one or more input/output (I/O) devices 206. In some embodiments, computing device 200 may take the form of a server, general purpose computer, mainframe computer, or any combination of these components. In some embodiments, computing device 200 may take the form of a mobile computing device such as a smartphone, tablet, laptop computer, or any combination of these components. Alternatively, computing device 200 may be configured as a particular apparatus, embedded system, dedicated circuit, or the like based on the storage, execution, and/or implementation of the software instructions that perform one or more operations consistent with the disclosed embodiments.

Internal communication bus 201 may be configured to implement data communications between components of computing device 200. Processor 202 may implement program instructions to complete one or more functions, components, modules, units, sub-units of system 100 disclosed herein. Processor 202 may include one or more known processing devices, such as mobile device microprocessors or any various other processors. For example, processor 202 may include such as PIC microcontrollers, MIPS microcontrollers, etc., or more powerful microprocessors including the Pentium™ or Xeon™ family manufactured by Intel™, or the Turion™ family manufactured by AMD™. The disclosed embodiments are not limited to any type of processor(s) configured in computing device 200.

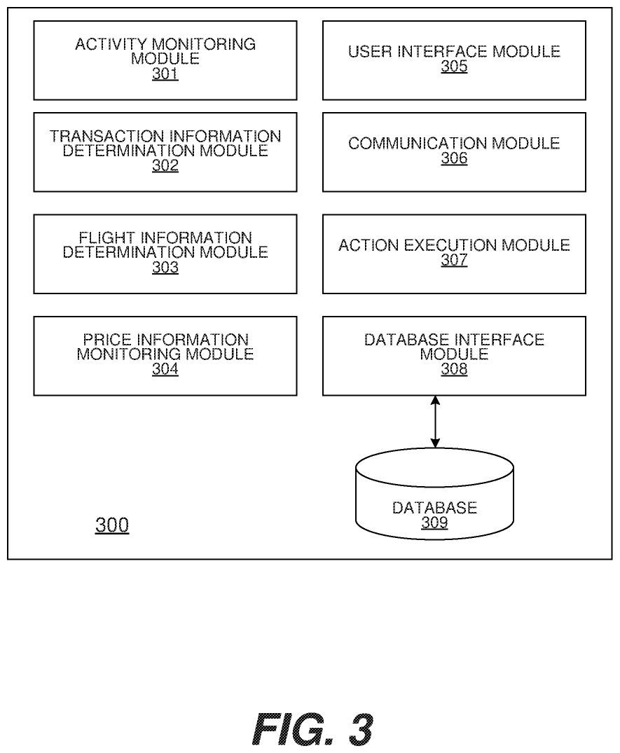

Computing device 200 may include different forms of program storage unit and data storage unit, such as memory 203 or hard disk 204. Memory 203 and hard disk 204 may include one or more storage devices configured to store instructions used by processor 202 to perform functions related to disclosed embodiments. For example, memory 203 may be configured with one or more software instructions that may perform one or more operations when executed by processor 202. The disclosed embodiments are not limited to separate programs or computers configured to perform dedicated tasks. For example, memory 203 and hard disk 204 may include one or more programs that perform the functions of computing device 200. Memory 203 and hard disk 204 may also store data used by one or more programs. In certain embodiments, memory 203 and hard disk 204 may store software that may be executed by Processor(s) 202 to perform one or more processes consistent with disclosed embodiments. Hard disk 204 may be implemented as a nonvolatile, solid-state memory. Memory 203 and hard disk 204 may also store instructions for various modules illustrated in FIG. 3 to perform one or more functions of the disclosed embodiments.

Communication port 205 may be configured for connecting with a network (e.g., network 107) to facilitate data communications. Computing device 200 may also be communicatively connected to one or more of storages 106 through network 107 via communication port 205.

I/O devices 206 may be one or more devices configured to allow data to be received and/or transmitted by computing device 200. I/O devices 206 may include one or more digital and/or analog devices that allow computing device 200 to communicate with other machines and devices, such as other components of system 100. I/O devices 206 may also include one or more digital and/or analog devices that allow a user to interact with computing device 200 such as a touch-sensitive area, keyboard, buttons, or microphones. I/O devices 206 may also include other components known in the art for interacting with a user.

The components of computing device 200 may be implemented in hardware, software, or a combination of both hardware and software, as will be apparent to those skilled in the art. For example, although one or more components of computing device 200 may be implemented as computer processing instructions, all or a portion of the functionality of computing device 200 may instead be implemented in dedicated electronics hardware.

FIG. 3 is a block diagram of an exemplary automation engine 300 for servicing a user's flight, consistent with disclosed embodiments. One or more components of system 100 may include automation engine 300 for servicing a user's flight. For example, flight monitor server 101 may include one or more storage devices (e.g., implemented on memory 203 and/or hard disk 204) storing instructions for the modules of automation engine 300 illustrated in FIG. 3. Automation engine 300 includes an activity monitoring module 301, a transaction information determination module 302, a flight information determination module 303, a price information monitoring module 304, a user interface module 305, a communication module 306, an action execution module 307, a database interface module 308, and/or a database 309.

Generally, the word “module,” as used herein, refers to logic embodied in hardware or firmware, or to a collection of software instructions. The modules described herein may be implemented as software and/or hardware modules and may be stored in any type of non-transitory computer-readable medium or another storage device. In some embodiments, a software module can be compiled and linked into an executable program. It will be appreciated that software modules can be callable from other modules or themselves, and/or can be invoked in response to detected events or interrupts. Software modules configured for execution on computing devices (e.g., processor 202) can be provided on a computer-readable medium, such as a compact disc, digital video disc, flash drive, magnetic disc, or any other tangible medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedded in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. In general, the modules described herein refer to logical modules that can be combined with other modules or divided into sub-modules despite their physical organization or storage.

Activity monitoring module 301 may be configured to automatically monitor a user's online activities at a user device associated with the user without the user's input and/or intervention. For example, activity monitoring module 301 may use a background process to monitor the user's online activities that occur at user device 102.

Transaction information determination module 302 may be configured to identify one or more transactions according to the activities of the user. For example, transaction information determination module 302 may monitor an email account of the user and analyze an email received from airline service provider server 103. Transaction information determination module 302 may identify a transaction of booking a flight in the email based on analysis of the email.

Flight information determination module 303 may be configured to detect one or more booked flights according to the identified transaction(s). For example, flight information determination module 303 may determine that the email from which the transaction is identified also includes an itinerary of the user, which may be detected as a booked flight. Flight monitor server 101 may also extract the flight information from the email (e.g., itinerary information, confirmation code, etc.).

Price information monitoring module 304 may be configured to monitor price information associated with the booked flight. For example, price information monitoring module 304 may automatically track the price of the airline ticket of the same flight available for purchase on one or more websites (or through an application program interface (API) to one or more websites) operated by airline service provider server 103 and/or third-party vendor server 104.

User interface module 305 may be configured to cause user device 102 to display a user interface. For example, user interface module 305 may cause user device 102 to display a user interface requesting the confirmation code of a booked flight. Merely by way of example, flight monitor server 101 may, through user interface module 305, activate an application to pop up showing a user interface in user device 102 configured to request a confirmation code. The user interface may also include a field for receiving the user's input at user device 102, and the user may enter the confirmation code in the field shown in the user interface. Flight monitor server 101 (through communication module 306) may receive the confirmation code determined according to the user's input at the user interface.

Communication module 306 may be configured to facilitate communications between the device on which it is implemented (e.g., flight monitor server 101) and another component of system 100 (e.g., user device 102). For example, flight monitor server 101 may transmit a request for initiating flight adjustment to user device 102 through communication module 306. As another example, flight monitor server 101 may transmit a request for adjusting a booked flight to airline service provider server 103 through communication module 306.

Action execution module 307 may be configured to automate a process of adjusting the booked flight. For instance, action execution module 307 may automatically generate a request for a refund according to a refund request script.

Database interface module 308 may be configured to receive and interpret a database request. Database interface module 308 may also obtain data from and/or save data into database 309 according to the database request. For example, flight monitor server 101 may save transaction information, flight information, and user information into database 309 through database interface module 308. Database 309 may be configured to store and maintain data in a structured form. Database 309 may include one or more of Oracle™ databases, Sybase™ databases, or other relational databases or non-relational databases, such as Hadoop sequence files, HBase, or Cassandra.

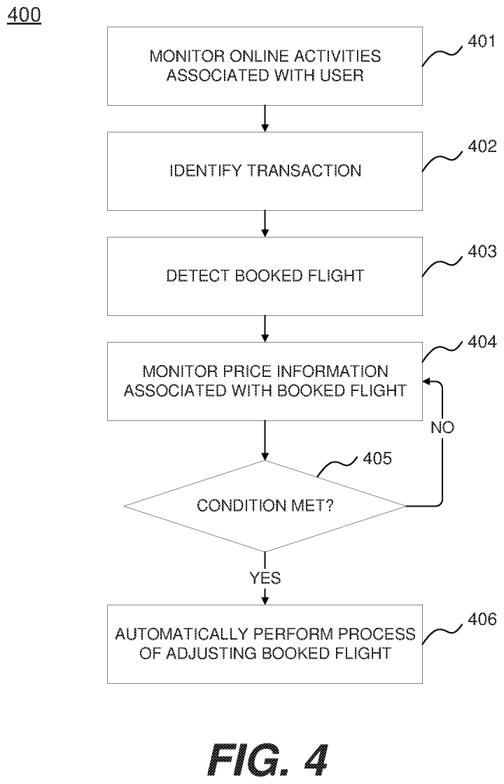

FIG. 4 is a flowchart of an exemplary process 400 for automatically adjusting a booked flight for a user, consistent with disclosed embodiments. One or more operations of Process 400 may be performed by flight monitor server 101 and/or user device 102 (e.g., by various modules illustrated in FIG. 3 and disclosed herein). For brevity, the steps of process 400 are described below using flight monitor server 101 as the performer of the steps in exemplary embodiments. However, one having ordinary skill in the art will now understand that one or more steps can be performed by other components of system 100 (e.g., user device 102). These exemplary embodiments are not intended to limit the scope of the disclosure.

At step 401, flight monitor server 101 (e.g., by activity monitoring module 301) automatically monitors online activities associated with a server or a user device (e.g., a user device 102) associated with the user without the user's input and/or intervention. For example, flight monitor server 101 (or user device 102 at the direction of flight monitor server 101) may use a background process to monitor the user's online activities that occur at user device 120. By way of example, an application for monitoring activities may be installed in user device 102 configured to track the user's activities or actions in a web browser of user device 102. Alternatively or additionally, the application may transmit online activities of the user (e.g., the browsing history of the user) at user device 102 to flight monitor server 101. By monitoring the user's activities automatically, the systems and methods disclosed herein may relieve the user from tedious, labor-intensive, time-consuming work of recording the activities and information that may be used to effect adjustment of a booked flight (e.g., requesting for a price adjustment, canceling a booked flight).

In some embodiments, in addition or alternative to monitoring the user's activities by user device 102, flight monitor server 101 may monitor online activities associated with the user that occur at a server (e.g., through one or more online accounts of the user hosted by a server). Exemplary online accounts of the user to be monitored include the user's email account, social media account, airline account, financial account (e.g., credit card account, banking account, etc.), or the like, or a combination thereof. Flight monitor server 101 may access information relating to the user's activities using account authentication information (e.g., username, password, security questions and answers, access token, etc.) previously provided by the user. For example, flight monitor server 101 may monitor an email account of the user hosted by a third-party email server (or hosted by flight monitor server 101). Flight monitor server 101 may access information relating to emails in the email account using the credentials previously provided by the user. For instance, the user may provide the username and password of the email account to flight monitor server 101. Flight monitor server 101 may then use the credential information to log into the email account or request the email server to provide certain information (e.g., transaction information). Alternatively or additionally, the user (or the email server after receiving the approval from the user) may transmit an access token (e.g., an OAuth token) to flight monitor server 101, and flight monitor server 101 may use the token to access the information relating to emails in the email account hosted by the email server.

Exemplary online activities of the user to be monitored may include messages received and sent out, emails received and sent out, social media communications, activities by the user using a web browser at websites, purchases made with a web browser or an application installed in user device 102 (e.g., a mobile application operated by airline service provider server 103), transaction records accessible by user device 102 (e.g., transaction records accessible by an application operated by a Financial Service Provider 106), or the like, or a combination thereof. For example, flight monitor server 101 or user device 102 may analyze an email received by user device 102 (e.g., in an email application, a web browser accessing an email account of the user). The email may be parsed automatically, and the e-mail header information and content may be extracted and analyzed for further processing. Merely by way of example, user device 102 may receive an email from an email address of an airline company to confirm a booked flight after the user booked an airline ticket with the airline. Flight monitor server 101 (e.g., by activity monitoring module 301) or user device 102 may analyze the email (e.g., the email address, header information, email body) and determine that the email relates to a transaction made by the user.

In some embodiments, before monitoring any activities of the user, flight monitor server 101 may obtain authorization from the user. For example, flight monitor server 101 may transmit a request for authorizing the monitoring to user device 102. In response, the user may provide the authorization via a user interface at user device 102. The user may also configure the system settings of user device 102 to enable flight monitor server 101 to monitor activities. In some embodiments, the user may specify the types of activities to be monitored and the types of activities not subject to monitoring. For example, the user may only allow flight monitor server 101 and/or user device 102 to monitor a specific email account (and the emails received and sent out by the email account), while other types of the activities are not to be monitored. Flight monitor server 101 and/or user device 102 may accordingly monitor only the email account specified by the user. As another example, the user may authorize flight monitor server 101 to monitor an email account hosted by an email server, but not to monitor the user's activities of user device 102. Accordingly, instead of monitoring the user's activities occurring at user device 102, flight monitor server 101 may access information relating to emails in the email account through the email server using authentication information previously provided by the user.

At step 402, flight monitor server 101 (e.g., transaction information determination module 302) identifies one or more transactions according to the activities of the user. For example, flight monitor server 101 (or user device 102 under the direction of flight monitor server 101) may monitor an email account of the user and analyze an email received from a third-party travel agent (e.g., via third-party vendor server 104), and identify that the email relates to a transaction of a booked flight for $360. As another example, flight monitor server 101 may monitor browsing activities of the user at an airline website. Flight monitor server 101 may determine that the user paid $100 for a seat upgrade, which may be identified as a transaction.

Flight monitor server 101 may save information relating to the transaction in a user account database stored into a storage device (e.g., memory 203, hard disk 204, storage 106) through database interface module 308. For example, flight monitor server 101 may create a user account for the user in the user account database. The user account database may be maintained in database 309. Flight monitor server 101 can then save the transaction information into the user account. Exemplary transaction information may include a monetary amount of the transaction, type of the transaction (e.g., airfare related), payment method (e.g., debit card information, credit card information, PAYPAL account information), payee information, transaction date, or the like, or a combination thereof. The user account may also include information of the user. Exemplary user information may include the user's name, telephone number, billing address, social security number, credential information of online accounts (e.g., email, airline, third-party vendor online account(s) to be monitored), or the like, or a combination thereof.

At step 403, flight monitor server 101 (e.g., by flight information determination module 303) detects one or more booked flights according to the identified transaction(s). For example, flight monitor server 101 may determine that the email from which the transaction is identified also includes an itinerary of the user, which may be detected as a booked flight. Flight monitor server 101 may also extract the flight information from the email (e.g., itinerary information, confirmation code, etc.).

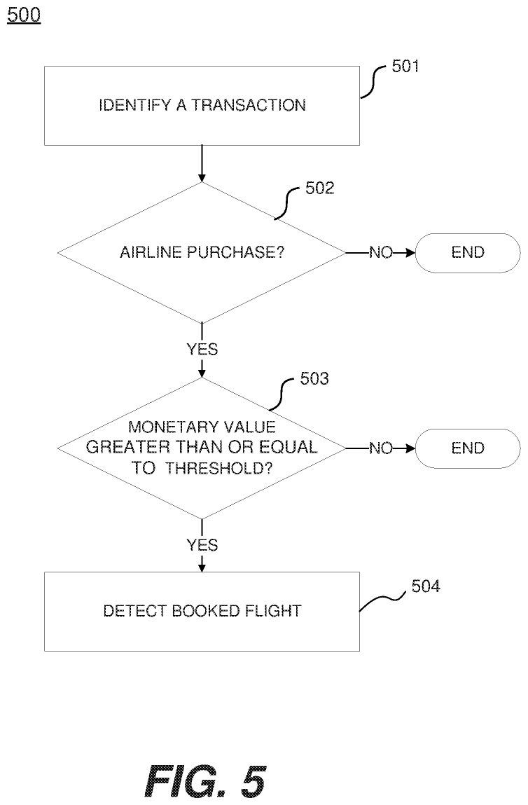

In some embodiments, flight monitor server 101 may determine a flight as a booked flight only after a confirmation code of the flight is obtained. For example, flight monitor server 101 may identify a transaction of an airline ticket in an email received at user device 102 from third-party vendor server 104. Third-party vendor server 104 may have already charged the user for the airline ticket, but the airline ticket has not been confirmed by airline service provider server 103. In other words, the user has not received a confirmation code from airline service provider server 103. Flight monitor server 101 may label the flight as a booked flight after a confirmation code has been received and/or verified. Flight monitor server 101 may detect a confirmation code in another email received at user device 102. As another example, flight monitor server 101 may transmit a request for the confirmation code to user device 102. Further description of requesting a confirmation code from the user can be found elsewhere in this disclosure (e.g., FIG. 5 and descriptions thereof).

In some embodiments, flight monitor server 101 and/or user device 102 may also obtain the flight information of the booked flight. The flight information may be obtained from information relating to the identified transaction. For example, the flight information may be included in the email received by user device 102 or the confirmation page when the user completes the purchase of the airline ticket at the website operated by airline service provider server 103 or third-party vendor server 104, and such information may be extracted by flight monitor server 101. Alternatively or additionally, flight monitor server 101 may obtain the flight information from a third party (e.g., airline service provider server 103, third-party vendor server 104, or the like, or a combination thereof) according to the information relating to the transaction and/or the user information. For example, flight monitor server 101 may log into an account of the user operated by airline service provider server 103 (with prior authorization by the user) on behalf of the user. Flight monitor server 101 may also obtain the flight information in the user account. Merely by way of example, flight monitor server 101 may use the same web browser as the user generally uses at user device 102 (which may be specified by the user or obtained from the monitored activities by the user at user device 102) to log into the user account using credentials previously provided by the user previously. After logging into the user account, flight monitor server 101 may also retrieve and/or compile flight information of the booked flight from the user account.

In some embodiments, flight monitor server 101 may also receive verification information, which may be used for the login. For example, the user's account with an airline may have multi-factor authentication, which may require both user credentials and a verification code sent to the user's email account and/or a user device of record. Flight monitor server 101 may automatically monitor the user's email account and/or message application installed in user device 102 and obtain the verification information if the email account and/or user device 102 receives the verification information. Alternatively or additionally, user device 102 may transmit the verification information it receives to flight monitor server 101. Flight monitor server 101 may further log into the user's account using the user credentials and verification information.

Exemplary flight information of a booked flight may include the airfare (e.g., monetary value or rewards points), the flight number, confirmation code, departure date and time, arrival date and time, departure and arrival cities, class, seat, flight segments, policy for adjusting the flight (e.g., changing and/or canceling the flight), restrictions, airline fees (e.g., fees for checking in luggage), or the like, or a combination thereof.

Flight monitor server 101 may also save the flight information of the booked flight into the user account in the user account database. For example, flight monitor server 101 may save the flight information of the booked flight into the user account along with the transaction information associated with the booked flight. Flight monitor server 101 may further store relevant information in the user account. For instance, the user may book a rental car and hotel for the same trip. Flight monitor server 101 may also identify and store such information in the user account. Flight monitor server 101 may further associate such information with the booked flight.

In some embodiments, flight monitor server 101 may maintain multiple user accounts stored in the user account database. Each user account may include user information, transaction information of one or more transactions, flight information of booked flight(s), etc. A user account may be updated when new information associated with that user is available. For example, when a booked flight is identified by flight monitor server 101, relevant transaction information and flight information may be saved to the user account.

In some embodiments, user device 102 may detect a booked flight and transmit to flight monitor server 101 a request for monitoring price information associated with the booked flight. The request for monitoring price information may include the flight information of the booked flight and the transaction information. In some embodiments, the request may also include the confirmation code associated with the booked flight. In response, flight monitor server 101 may monitor price information associated with the booked flight, as described below.

At step 404, flight monitor server 101 (e.g., by Price information Monitoring Module 304) monitors price information associated with the booked flight. For example, flight monitor server 101 may automatically track the price of the airline ticket of the same flight available for purchase on one or more websites (or an API to one or more websites) operated by airline service provider server 103 and/or third-party vendor server 104. Flight monitor server 101 may also log into the user account operated by the airline of the booked flight using the user's credentials previously provided by the user and obtain the price information of the booked flight from the user account. Alternatively or additionally, flight monitor server 101 may intermittently submit to a computerized reservation system or global distribution system an inquiry requesting price information associated with the booked flight. Price information to be monitored and obtained may include the price of an airline ticket of the monitored flight that is available for purchase, the number of airline tickets available, other airline fees (e.g., fees for check-in luggage), or the like, or a combination thereof. In some embodiments, the monitored price information associated with the booked flight may include a monitored price of an airline ticket of the booked flight that occurs after the occurrence of the purchased airline ticket of the booked flight.

In some embodiments, flight monitor server 101 may start monitoring price information only after it obtains and/or verifies the confirmation code. By requiring a verified confirmation code before monitoring, flight monitor server 101 can screen out users who do not have a booked flight and provide services only to users having a “booked flight.” Additionally, the confirmation code may be required later by the airline for adjusting a booked flight, and by verifying a confirmation code at an earlier stage, the automated process of adjusting the booked flight will not be interrupted due to an incorrect or missing confirmation code.

In some embodiments, flight monitor server 101 may monitor price information associated with a booked flight according to the information of multiple user accounts stored in the user account database. The user accounts may include transaction information for booked flight(s) (e.g., the price of an airline ticket of a booked flight associated with a particular user). Flight monitor server 101 may monitor the prices of the airline tickets purchased by the users according to the transaction information and flight information of these users' booked flights. For example, user A purchases an airline ticket for a flight on March 8 for $300, and flight monitor server 101 identifies the booked flight by user A and saves relevant information into the user account database. Twenty hours later, user B purchases an airline ticket for the same flight for $250, and flight monitor server 101 also identifies the booked flight by User B and saves relevant information into the user account database. Flight monitor server 101 further obtains the transaction information and flight information of this more recent flight booked by user B (without revealing the identity of user B) as part of monitoring price information of the booked flight of user A because such information may be useful for identifying a more recent price of the airline ticket of user A's booked flight. For instance, flight monitor server 101 may periodically track the price information for user A, and the change of the price may occur when Flight Monitor Server is not checking the price. Once flight monitor server 101 has the relevant information from user B, flight monitor server 101 may check the price on the airline and/or third-party websites and update the price for user A accordingly. Flight monitor server 101 may also save the evidence of a lower price (e.g., a screenshot of the price of an airline ticket available for purchase on the airline website).

In some embodiments, flight monitor server 101 may monitor price information based on the transaction data maintained by Financial Service Provider 105. For example, Financial Service Provider 105 (e.g., a credit card service provider) may aggregate the transaction data of its customers, which may be maintained in a transaction database. Some of the transaction data may relate to airline ticket purchases. The transaction data of the airline tickets may include flight information such as flight numbers, departure date, in addition to the purchase prices of the airline tickets. Financial Service Provider 106 may extract relevant data and save the data into a flight price database. Flight monitor server 101 may access the flight price database and search for price information of a particular flight. For example, flight monitor server 101 may find in the flight price database a more recently purchased ticket for the same flight of a booked flight by a user. Flight monitor server 101 may further check the price of the same flight on a website hosted by airline service provider server 103 (or third-party vendor server 104) and save the proof of a lower price (e.g., a screenshot showing the price).

In some embodiments, flight monitor server 101 may extract price information of flights from the airline and/or third-party vendor websites using web scraping tools. For example, flight monitor server 101 may use web scraping tools such as the Hypertext Transfer Protocol, a web browser, and/or an API to extract data from the websites. A web scraping tool may automatically recognize the data structure of a webpage, interact with the relevant elements of that structure to navigate to a page with pricing information, and extract the relevant price information accordingly. Flight monitor server 101 may also save the extracted price information into a flight information database. Flight monitor server 101 may further determine a more recent price of a particular flight based on the stored price information in the flight information database.

Exemplary web scraping tools include tools based on the UNIX grep command or regular expression-matching tools of programming languages (e.g., PERL or PYTHON), Hypertext Transfer Protocol (HTTP) requests (e.g., HTTP GET and POST requests), HyperText Markup Language (HTML) parsers, Document Object Model (DOM) parsing, computer vision, natural language processing, and vertical aggregation harvesting platforms.

In some embodiments, price information may be monitored during a predetermined period. For example, flight monitor server 101 may start monitoring the price information of a booked flight after the booked flight is identified and continue monitoring until a time point before the departure time of the booked flight. Merely by way of example, flight monitor server 101 may obtain the departure time of the booked flight from the user account database (or the flight information database). Flight monitor server 101 may determine a period for monitoring the price information according to the departure time. For instance, flight monitor server 101 may stop monitoring the price information 24 or 48 hours before the departure time of the booked flight. Alternatively or additionally, flight monitor server 101 may determine a period for monitoring the price information of the booked flight based on the policy of the airline for adjusting the booked flight (e.g., canceling or changing the flight). For example, an airline may prohibit the cancellation of a booked flight after a certain time from the booking. Flight monitor server 101 may obtain the relevant policy of the airline and determine the period during which flight monitor server 101 may monitor the price information. As another example, an airline may have a policy that the airline may not charge any fee or impose any penalty for canceling a booked flight within 24 hours of the booking. Flight monitor server 101 may monitor the price information within the non-penalty period (i.e., within 24 hours of the booking).

In some embodiments, flight monitor server 101 may determine a first period and a second period during which the monitoring of price information occurs at different frequencies according to the departure time and/or the policy of the airline. For example, flight monitor server 101 may monitor price information every 30 minutes in the first period (e.g., within 24 hours of the booking) and every 12 hours in the second period (e.g., after 24 hours and till the departure time).

In some embodiments, flight monitor server 101 may also monitor price information of a flight similar to the booked flight. For example, flight monitor server 101 may determine one or more alternative flights to the booked flight (also referred to herein as recommended flights) based on the information of the booked flight, and monitor the price information of the recommended flight(s). Merely by way of example, the booked flight may be from Washington Dulles International Airport in the metropolitan area of Washington, D.C., to San Francisco International Airport in San Francisco, Calif. on March 8 departing at 7 AM EST. Flight monitor server 101 may determine one or more alternatives that have a different but comparable departure airport (e.g., departing from Ronald Reagan Washington National Airport), arrival airport (e.g., Mineta San Jose International Airport), departure time (e.g., within an hour of the departure time of the booked flight), or a combination thereof. Flight monitor server 101 may monitor the price information of the recommended flight(s) in addition to the booked flight. In some embodiments, flight monitor server 101 may obtain user preference for recommending a flight to the user from the user account and recommend one or more flights to the user based on the user preference and the booked flight. For instance, the user may specify in the user preference that the departure time of a recommended flight by flight monitor server 101 can only be within one hour before or after the scheduled departure time of the booked flight. The user may also specify other criteria for flight monitor server 101 to recommend a flight, including, for example, the airline(s), the airport(s), arrival time, the number of flight segments (e.g., non-stop, two segments, three segments), or the like, or a combination thereof.

In some embodiments, flight monitor server 101 may save proof of a current price of an airline ticket of the monitored flight (e.g., the booked flight, the recommended flight) in a storage device. The term “current price” of an airline ticket used herein refers to the price of the airline ticket shown at the time when flight monitor server 101 identifies on an airline or third-party vendor website (or a computerized reservation system) while monitoring price information associated with the booked flight. For example, flight monitor server 101 may capture a screenshot of the web page at an airline or third-party vendor website (or a response by a computerized reservation system to a query sent by flight monitor server 101) that shows the price of an airline ticket of the monitored flight available for purchase.

In some embodiments, user device 102 may transmit to flight monitor server 101 a request for monitoring price information associated with the booked flight. Flight monitor server 101 may monitor price information as described above.

At step 405, flight monitor server 101 (e.g., by action execution module 307) determines whether a condition for adjusting the booked flight is met based on the monitored price information. Adjusting a booked flight may include canceling the booked flight and repurchasing an airline ticket of the booked flight or a recommended flight, or requesting a refund. For example, the condition for adjusting the booked flight may include a condition that the difference between the price of the purchased airline ticket of the booked flight and the monitored price of the airline ticket of the booked flight is greater than or equal to a threshold amount. Merely by way of example, assuming that the price of the booked flight is $300 and the threshold amount is $40, if the monitored price of the same flight discovered by flight monitor server 101 is $250, flight monitor server 101 will determine the condition for adjusting the booked flight is met because the difference (i.e., $50) is greater than the threshold amount (i.e., $40). By specifying a threshold amount for determining whether to adjust the booked flight, flight monitor server 101 may strike a balance between making too many flight adjustments and making no adjustment even if the user may benefit from a certain adjustment.

The threshold amount may be specified by the user via user device 102 or by flight monitor server 101. The threshold amount may be saved in the user account. In some embodiments, the threshold amount may be a percentage of the price of the airline ticket purchased by the user or a monetary (or rewards points) amount. For example, the threshold amount may be 10% of the price of the booked flight or $40 or relate to a combination thereof (e.g., the lesser or greater of the 10% of the price of the booked flight or $40). In some embodiments, flight monitor server 101 may take the required fees to adjust the booked flight into consideration in determining the threshold amount for adjusting the booked flight. For example, the threshold amount may be a percentage of the price of the airline ticket purchased by the user or a monetary (or rewards points) amount plus the penalty for canceling the booked flight.

If flight monitor server 101 determines that the condition is not met, process 400 proceeds to step 405, and flight monitor server 101 (e.g., by Price information Monitoring Module 304) continues monitoring price information associated with the booked flight.

If flight monitor server 101 determines that the condition is met, process 400 proceeds to step 406. At step 406, flight monitor server 101 (e.g., action execution module 307) may automatically perform a process of adjusting the booked flight. For instance, flight monitor server 101 may automatically generate a request for a refund. The amount of the refund specified in the request may be the difference between the price of the booked flight and a currently monitored price. Flight monitor server 101 may also submit the generated request to a party handling such requests. For example, flight monitor server 101 may submit the request for a refund to airline service provider server 103. Alternatively, flight monitor server 101 may submit the request to third-party vendor server 104 or Financial Service Provider 106, which may provide a price match or guarantee program. As another example, flight monitor server 101 may automatically perform a process of canceling the booked flight and rebooking the flight. Flight monitor server 101 may log into the user's airline account on behalf of the user, and cancel and rebook the flight.

In some embodiments, flight monitor server 101 may obtain and/or monitor the result of the adjustment. For example, flight monitor server 101 may determine whether the request for refund has been approved by the airline by monitoring the user's email account and incoming email(s) regarding the request. As another example, flight monitor server 101 may determine that the booked flight has been canceled and an airline ticket of the same flight (or a different flight) has been purchased at the desired price according to the confirmation page shown on the airline website after the purchase by flight monitor server 101. Flight monitor server 101 may further transmit a notification indicating the result to the user at, for example, user device 102. The notification may also include the benefit the user gains from the flight adjustment if the adjustment succeeds. The notification may be in the form of email, text message, push-up notification, or the like, or a combination thereof.

In some embodiments, flight monitor server 101 may determine and charge a service fee for the service if the adjustment is successful (or regardless of the result). The service fee may be a fixed fee. Alternatively, the service fee may be determined according to the benefit that the user gains from the flight adjustment (e.g., a percentage of the amount savings the user realizes).

In some embodiments, before starting the process for adjusting the booked flight, flight monitor server 101 may transmit a request for the adjustment to the user asking for approval at user device 102. The request transmitted to the user may include information to help the user to decide whether to take action or not. For example, the request may include the action to take (e.g., submitting a request for a refund), a screenshot showing the monitored price of the booked flight (or a different flight), the benefit the user may realize if the adjustment succeeds, the deadline to take action, the time frame for expecting a result, or the like, or a combination thereof. The request may also include an estimated success rate. Flight monitor server 101 may estimate the success rate according to statistical information of similar situations that occurred in the past (e.g., requests that flight monitor server 101 or other parties handled). The user may further transmit a response to flight monitor server 101 via user device 102 indicating whether flight monitor server 101 can take action on the user's behalf. In response, flight monitor server 101 may take action if the user approves or may not take any action if the user decides not to take action.

In some embodiments, the request for the adjustment to the user, transmitted to user device 102, may include an option for the user to take action to adjust the booked flight (instead of flight monitor server 101 taking action). For example, flight monitor server 101 may cause the user interface of user device 102 to display multiple options from which the user can choose, including a first option to authorize flight monitor server 101 to adjust the booked flight on the user's behalf and a second option for the user to act. If the user selects the second option via an input to user device 102, the user interface may show the information and instructions about how the user can adjust the booked flight. For example, the user interface may display the flight information, transaction information, contact information (e.g., telephone number, email address, etc.) to request the adjustment to the booked flight, the action to take (e.g., submitting a request for a refund), a screenshot showing the monitored price of the booked flight (or a different flight), the benefit the user may realize if the adjustment succeeds, the deadline to take action, the time frame for expecting a result, or the like, or a combination thereof. The user may then take action to adjust the booked flight according to the information provided by flight monitor server 101.

FIG. 5 is a flowchart of an exemplary process 500 for detecting a booked flight based on information relating to a transaction, consistent with disclosed embodiments. In some embodiments, steps 402 and 403 of process 400 illustrated in FIG. 4 may be performed based on process 500. Process 500 may be performed by one or more components of system 100 (e.g., flight monitor server 101 and/or user device 102). For brevity, the steps of process 500 are described below using flight monitor server 101 as the performer of these steps in exemplary embodiments. However, one having ordinary skill in the art will now understand that one or more steps can be performed by other components of system 100 (e.g., user device 102). These exemplary embodiments are not intended to limit the scope of the disclosure.

At step 501, flight monitor server 101 identifies a transaction. Step 501 may be the same as or similar to step 402 of process 400, and for brevity, similar descriptions for step 501 are not repeated in detail here.

At step 502, flight monitor server 101 may determine whether the identified transaction relates to an airline ticket purchase based on information relating to the transaction. For example, flight monitor server 101 may determine that an identified transaction is a reservation of a flight. As another example, flight monitor server 101 may determine that the transaction is a fee for check-in luggage. As a further example, flight monitor server 101 may determine that the transaction is an in-flight purchase (e.g., the fee for on-board WiFi™ service).

In some embodiments, flight monitor server 101 may determine that the transaction relates to an airline ticket purchase, but may not be able to determine what the transaction is. For example, flight monitor server 101 may only have the information that the payment recipient is an airline. Flight monitor server 101 may then need to determine whether this transaction relates to a booked flight based on the monetary value of the transaction at steps 503 and 504 described below.

If flight monitor server 101 determines that the transaction does not relate to an airline ticket purchase, process 500 ends. If flight monitor server 101 determines that the transaction relates to an airline ticket purchase, process 500 proceeds to step 503.

At step 503, flight monitor server 101 determines whether the monetary value of the transaction is greater than or equal to a threshold amount. For example, flight monitor server 101 may extract the monetary value from the transaction information and compare the monetary value with the threshold amount. If flight monitor server 101 determines that the monetary value is less than the threshold amount, process 500 ends. If flight monitor server 101 determines that the monetary value is greater than or equal to the threshold amount, process 500 proceeds to 504.

At step 504, flight monitor server 101 detects a booked flight. For example, assuming that the threshold amount is $100, flight monitor server 101 determines a transaction that has a monetary value of $120 as an airline ticket purchase. Flight monitor server 101 may also detect a booked flight as described above in connection with step 403 of process 400 illustrated in FIG. 4. Step 504 may be the same as or similar to step 402 of process 400.

In some embodiments, step 503 may be performed before step 502. For example, after identifying a transaction, at step 503, flight monitor server 101 may determine whether the monetary value of the transaction exceeds a threshold amount. If so, flight monitor server 101 may, at step 502, determine whether the transaction relates to an airline ticket purchase. If so, process 500 proceeds to step 504; otherwise, process 500 ends. Alternatively, steps 502 and 503 may be performed simultaneously, and if the results of both determinations at steps 502 and 503 are “Yes,” process 500 proceeds to step 504. On the other hand, if one of the results of the determinations at steps 502 and 503 is “No,” process 500 ends.

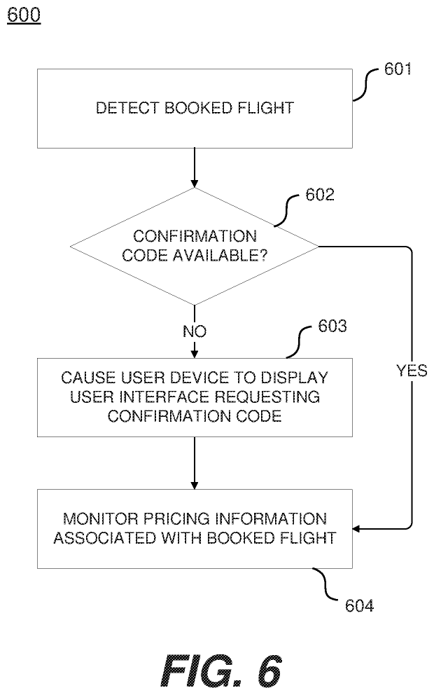

FIG. 6 is a flowchart of an exemplary process 600 of monitoring price information associated with a booked flight, consistent with disclosed embodiments. In some embodiments, steps 403 and 404 of process 400 illustrated in FIG. 4 may be performed according to process 600. Process 600 may be performed by one or more components of system 100 (e.g., flight monitor server 101, user device 102). For brevity, the steps of process 600 are described below using flight monitor server 101 as the performer of these steps in exemplary embodiments. However, one having ordinary skill in the art will now understand that one or more steps can be performed by other components of system 100 (e.g., user device 102). These exemplary embodiments are not intended to limit the scope of the disclosure.

At step 601, flight monitor server 101 (e.g., by flight information determination module 303) detects one or more booked flights according to the identified transaction(s). Step 601 may be the same as or similar to step 403 of process 400, and for brevity, similar description for step 601 is not repeated in detail here.

At step 601, flight monitor server 101 (e.g., by flight information determination module 303) determines whether a confirmation code for the booked flight is available. For example, flight monitor server 101 may determine whether information relating to the transaction associated with the booked flight includes a confirmation code. Merely by way of example, flight monitor server 101 may identify a transaction of the purchase of an airline ticket in an email received by user device 102 from airline service provider server 103. Flight monitor server 101 may also determine whether the email includes a confirmation code associated with the booked flight. As another example, the user may use user device 102 to purchase an airline ticket through the website operated by airline service provider server 103 or third-party vendor server 104 (or an application installed on user device 102). A confirmation page on the website (or the application) appearing after the user purchases the airline ticket may include the confirmation code. By using a background process at user device 102, flight monitor server 101 may identify and obtain the confirmation code. As a further example, flight monitor server 101 may obtain the confirmation code associated with the booked flight by logging into the user's airline account on behalf of the user with credentials provided by the user, and retrieve the confirmation code from the account.

At step 602, if flight monitor server 101 determines that a confirmation code is not available, process 600 proceeds to step 603, where flight monitor server 101 (e.g., by user interface module 305) causes user device 102 to display a user interface requesting the confirmation code. For example, flight monitor server 101 may activate an application to pop up showing a user interface configured to request a confirmation code. Merely by way of example, the user interface may include the flight and transaction information relating to the booked flight. The user interface may also include a field for receiving the user's input at user device 102, and the user may enter the confirmation code in the field shown in the user interface. Flight monitor server 101 may determine the confirmation code based on the user's input. Flight monitor server 101 may also verify the confirmation code received by checking the information available on the airline or third-party vendor website. For example, flight monitor server 101 may verify the confirmation code by entering the confirmation code it received and certain user information (e.g., the last name of the user) on a reservation page on the airline website. If flight monitor server 101 determines the confirmation code is incorrect, flight monitor server 101 may again request the confirmation code from the user via the user interface at user device 102. Alternatively or additionally, flight monitor server 101 may transmit a message, email, a link to a web page to request the confirmation.

At step 602, if flight monitor server 101 determines that a confirmation code is available or verified, process 600 proceeds to step 604, where flight monitor server 101 monitors price information associated with the booked flight. Flight monitor server 101 may also save the confirmation code associated with the booked flight into the user account. Step 604 may be the same as or similar to step 404, and for brevity, similar description for step 604 is not repeated in detail here.

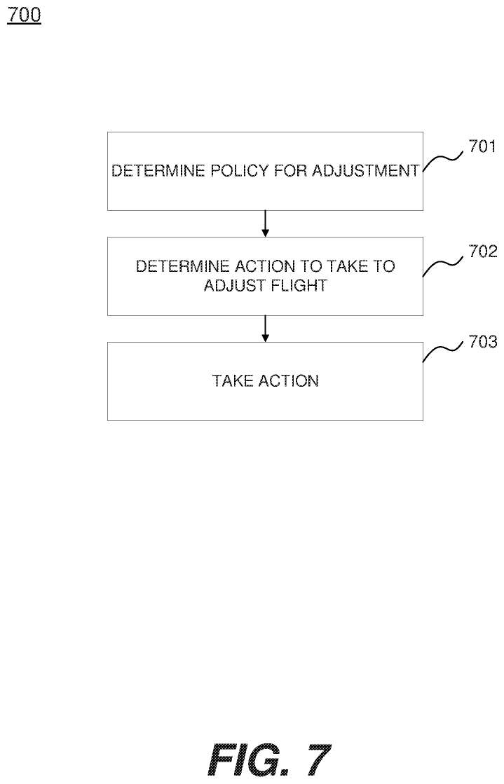

FIG. 7 is a flowchart of an exemplary process 700 of automatically performing an action for adjusting a booked flight, consistent with disclosed embodiments. In some embodiments, step 406 of process 400 illustrated in FIG. 4 may be performed according to process 700. Process 700 may be performed by one or more components of system 100 (e.g., flight monitor server 101, user device 102). For brevity, the steps of process 700 are described below using flight monitor server 101 as the performer of these steps in exemplary embodiments. However, one having ordinary skill in the art will now understand that one or more steps can be performed by other components of system 100 (e.g., user device 102). These exemplary embodiments are not intended to limit the scope of the disclosure.

At step 701, flight monitor server 101 (e.g., by action execution module 307) determines a policy for adjusting a booked flight. For example, flight monitor server 101 may obtain a policy of the airline (and/or the third-party vendor if the user books the flight through the third-party vendor) specifying the terms for canceling the booked flight or requesting a refund if a better price of the booked flight is available.

The policy may identify what actions a user may take to change a booked flight. For example, the policy may specify that the user can cancel the booked flight by using a telephone call, a mobile application, or online chat, but may only request for a refund by submitting a request via email. As another example, the policy may specify what information and proof is needed to request a refund (e.g., the proof of a better price of the booked flight on the airline's website). Merely by way of example, flight monitor server 101 may obtain a policy of an airline for canceling the booked flight stating that there is no charge for canceling within 24 hours of the booking, but a cancellation fee of $200 after 24 hours and before the departure time.

In some embodiments, flight monitor server 101 may generate rules based on an airline's policy for adjusting a booked flight. For example, flight monitor server 101 may generate rules such as “If cancellation <24 hours, $0,” “If cancellation >=24 hours, $200,” and so on. The rules may be in the form of data maintained in a database, and saved into and maintained in database 309. Flight monitor server 101 may obtain the rules for adjusting a booked flight instead of obtaining the airline policy directly from airline service provider server 103.

At step 702, flight monitor server 101 determines one or more actions to take to adjust the booked flight based on the obtained policy (and/or rules). Alternatively or additionally, flight monitor server 101 may also determine action(s) to take based on the transaction information, flight information, and/or price information associated with the booked flight. For example, flight monitor server 101 may determine the action to take is to submit a request for refund by sending an email to a designated email address operated by airline service provider server 103. The request for refund may include the amount of a refund that equals the difference between the price of the purchased airline ticket of the booked flight and the monitored price.

In some embodiments, flight monitor server 101 may determine the type of flight adjustment, the means by which action(s) may be taken, or the like, or a combination thereof. The type of flight adjustment may include submitting a request for a refund, canceling the booked flight and rebooking the same flight, or canceling the booked flight and booking a different flight (with the same airline or a different airline), or the like, or a combination thereof. The means by which the action(s) may be taken may include submitting a request for the adjustment via an automatic telephone call (e.g., using an artificial intelligent virtual assistant capable of making a telephone call on a user's behalf), email, mobile application, online form, online chat, and/or social media site. Flight monitor server 101 may also determine whether a login into the user's airline or third-party vendor account is required to take action. Alternatively or additionally, flight monitor server 101 (or an affiliated party) may transmit action information to a terminal device of a service provider, which will place a telephone call to adjust the booked flight on the user's behalf. The action information transmitted to the terminal device may include the flight information, transaction information, contact information (e.g., the telephone number, email address, etc.) to request the adjustment to the booked flight, the action to take (e.g., calling the airline), a screenshot showing the monitored price of the booked flight (or a different flight), the deadline to take action, the time frame for expecting a result, or the like, or a combination thereof. The service provider may place a telephone call to adjust the booked flight on the user's behalf based on the action information. Flight monitor server 101 and/or the service provider may also monitor results of the adjustment request, and once the results are received, flight monitor server 101 and/or the service provider would forward the results to the user via user device 102.

In some embodiments, flight monitor server 101 may generate a script for executing the action. The generated script may specify the steps of the action to take, the order of the steps, the tool to be used in each of the steps (e.g., a web browser to log into the user's account), the information needed for each of the steps (e.g., user information, flight information), or the like, or a combination thereof. For example, flight monitor server 101 may generate a script for submitting a request for refund to the airline that includes a step of obtaining a template for generating a request for refund to be submitted to airline A. The template may include a link pointing to a location of the template stored in a storage device and fields to be filled with user information, flight information, and/or transaction information. In some embodiments, the request may include the confirmation code of the booked flight. The script may also include locations of the fields in database 309 corresponding to the information to be filled into the template. The script may further include steps of automatically obtaining the information to be filled in the template from database 309 and filling the required information into the template to generate a request for refund. The script may also specify the tool to use to submit the request (e.g., the web browser to log into the user's email account, the user's email account to send an email to airline service provider server 103). The script may further include the content of the request and any additional information such as the proof of a monitored price. As another example, flight monitor server 101 may generate a script of adjusting the booked flight including the following: receiving user login information of an online account of the user associated with the airline service provider, from the at least one storage device; obtaining, from database 309, user information of the user; logging into, using a web browser without the user's input, the online account of the user; and submitting to the airline service provider the request for adjusting the booked flight in the online account of the user via one of an email, online form, and online chat.

At step 703, flight monitor server 101 takes the determined action(s) on the user's behalf. For example, flight monitor server 101 may execute the generated script for adjusting the booked flight on the user's behalf. According to a script prepared at step 702, flight monitor server 101 may receive user login information of an online account of the user associated with the airline service provider from a storage device and obtain, from database 309, user information of the user. Flight monitor server 101 may also log into the user's online account using a web browser without the user's input, and submit to the airline service provider a request to adjust the booked flight in the user's online account. The flight adjustment may be one of submitting a request for a refund, canceling the booked flight and rebooking the same flight, and canceling the booked flight and booking a different flight.

In some embodiments, before taking an action, flight monitor server 101 may transmit to the user (e.g., via user device 102) a request for initiating flight adjustment for the booked flight on the user's behalf. The request may be in the form of a push notification, link, email, or message. Alternatively or additionally, flight monitor server 101 may cause user device 102 to display a user interface configured to display the request for initiating flight adjustment. The user interface may also be configured to receive the user's input for responding to the request. The user may respond to the request for initiating flight adjustment by interacting with the user interface displayed on a display of user device 102. For example, the user may interact with the user interface in response to the request, and user device 102 may generate a response to the request indicative of the user's approval (or disapproval or modification of actions to take) based on the user's input received by the user interface. User device 102 may also transmit the response to flight monitor server 101. Flight monitor server 101 may take an action (or no action) based on the response received from user device 102. For example, flight monitor server 101 may submit a request for adjusting the booked flight on the user's behalf based on a response received from user device 102 indicative of approval by the user.

In some embodiments, the user interface to receive the user's input for responding to the request for initiating flight adjustment may include a plurality of adjustment options for the user to select. The options may include actions that are available, for example, submitting a request for refund, canceling the booked flight and rebooking the same flight, or canceling the booked flight and booking a different flight (with the same airline or a different airline), or the like, or a combination thereof. The user interface may also show the benefit the user would realize under each of the options. The user interface may be configured to receive the user's input for selecting one or more of the options. User device 102 may generate a response to the request for initiating flight adjustment based on the user's input (e.g., the user selects canceling the booked flight and rebooking the same flight). Flight monitor server 101 may take an action (or no action) according to the response received from user device 102.

The foregoing description has been presented for purposes of illustration. It is not exhaustive and is not limited to the precise forms or embodiments disclosed. Modifications and adaptations of the embodiments will be apparent from a consideration of the specification and practice of the disclosed embodiments. For example, the described implementations include hardware and software, but systems and methods consistent with the present disclosure can be implemented as hardware alone. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as examples only, with a true scope and spirit being indicated by the following claims and their full scope of equivalents.

1. A computer-implemented system for servicing a flight of a user, comprising:
at least one storage device storing instructions; and
at least one processor, when executing the instructions, configured to cause the system to perform operations comprising:
monitoring, using a background process, online activities associated with a first user that occur at a first user device associated with the first user;
identifying a transaction of the first user according to the activities;
accessing a first email account on the first user device;
identifying, within the accessed first email account, an email relating to the transaction;
detecting a purchase, at the first user device at a first price, of an airline ticket for a booked flight, based on the identified email within the first account;
determining whether the identified email within the first account comprises a confirmation code associated with the booked flight, the confirmation code being a unique identifier of the airline ticket;
upon determining that the identified email within the first account does not comprise a confirmation code, causing the first user device to display a user interface configured to receive a confirmation code;
obtaining a confirmation code associated with the purchase, based on a first input by the first user received in the user interface;
monitoring price information associated with the booked flight, wherein the monitoring comprises:
accessing a second email account on a second user device,
identifying an email in the second email account of a second user related to the booked flight, and
extracting flight information from the email in the second email account;
determining, based on the monitored price information, whether a condition for flight adjustment is met, the condition having been specified by a second input by the first user at the first user device; and
upon determining that the condition is met, submitting, to an airline service provider, a request for adjusting the booked flight, the request comprising the confirmation code.

2. The computer-implemented system of claim 1, wherein:
the monitored price information comprises a second price of an airline ticket for the booked flight that was set after the purchase; and
the condition for flight adjustment is that a difference between the first and second prices is greater than or equal to a threshold amount.

3. The computer-implemented system of claim 2, wherein the threshold amount is one of a percentage of the first price or a dollar amount.

4. The computer-implemented system of claim 2, wherein the threshold amount comprises a fee required to change or cancel the booked flight.

5. The computer-implemented system of claim 2, wherein submitting the request comprises:
transmitting, to the airline service provider, a request for a refund equal to the difference between the first and second prices.

6. The computer-implemented system of claim 2, wherein:
the operations further comprise:
capturing a screen shot of the monitored price information; and
saving the screen shot into the at least one storage device; and
the request comprises the screen shot.

7. The computer-implemented system of claim 1, wherein submitting the request comprises:
retrieving, from the at least one storage device, a request template, the request template being associated with the airline service provider;
obtaining, from a database stored in the at least one storage device, user information of the first user; and
generating the request by automatically filling the obtained user information into the request template.

8. The computer-implemented system of claim 1, wherein submitting the request comprises:
retrieving, from the at least one storage device, user login information of an online account of the first user associated with the airline service provider;
obtaining, from a database stored in the at least one storage device, user information of the first user;
in response only to obtaining the user information, logging into the online account of the first user; and
submitting the request using at least one of an email, an online form, or an online chat, the request comprising at least part of the obtained user information.

9. The computer-implemented system of claim 1, wherein:
the request comprises a first request;
the user interface is a first user interface; and
the operations further comprise:
before submitting the first request, transmitting, to the first user device, a second request for authorization to initiate flight adjustment for the booked flight;
receiving, at a second user interface, user input for responding to the second request; and
receiving a response at the second user interface, authorizing the second request; and
submitting the second request based on the received response.

10. The computer-implemented system of claim 9, wherein the second request is in a form of at least one of a push notification, a link, an email, or a message.

11. The computer-implemented system of claim 9, wherein the second user interface comprises a plurality of adjustment options for the user to select at the user interface, the adjustment options comprising at least one of cancellation of the booked flight or submission of a refund request for the booked flight.

12. The computer-implemented system of claim 9, wherein the second request comprises a screen shot of the second price.

13. The computer-implemented system of claim 1, wherein:
monitoring the online activities comprises analyzing an email received at the first user device; and
identifying the transaction comprises identifying the transaction based on the analysis.

14. The computer-implemented system of claim 1, wherein detecting a purchase comprises:
determining whether the transaction comprises an airline ticket purchase;
determining whether a monetary value of the transaction is greater than or equal to a threshold monetary value;
obtaining flight information based on:
a result of the determination that the transaction comprises an airline ticket purchase, and
a result of the determination that the monetary value is greater than or equal to the threshold monetary value; and
determining the booked flight based on the obtained flight information.

15. The computer-implemented system of claim 1, wherein the operations further comprise:
obtaining, from the at least one storage device, a departure time of the booked flight;
determining a time period for monitoring the price information associated with the booked flight according to the departure time; and
monitoring the price information within the determined time period.

16. The computer-implemented system of claim 1, wherein the operations further comprise:
obtaining, from the at least storage device, policy of flight adjustment of the airline service provider;
determining a time period for monitoring the price information according to the policy of flight adjustment; and
monitoring the price information within the determined time period.

17. The computer-implemented system of claim 1, wherein
monitoring the price information further comprises:
identifying, based on the email in the second email account, an airline ticket purchased by the second user for the booked flight; and
determining a price of the airline ticket purchased by the second user.

18. The computer-implemented system of claim 1, wherein monitoring the price information comprises:
obtaining user preference of the first user;
determining a flight alternative to the booked flight according to the user preference and flight information of the booked flight; and
monitoring prices of an airline ticket for the flight alternative and the booked flight.

19. A computer-implemented method for servicing a user's flight, the method comprising:
monitoring, using a background process at a first user device associated with a first user, an email account of the first user;
detecting an email received by the first user device based on the monitoring;
parsing the email received by the first user device to generate data fields;
identifying a transaction of the first user according to the data fields;
obtaining information relating to the transaction from the parsed email;
detecting a purchase, at the first user device at a first price, of an airline ticket for a booked flight, based on the information;
determining whether the information comprises a confirmation code associated with the booked flight, the confirmation code being a unique identifier of the airline ticket for the booked flight;
upon determining that the transaction information does not comprise a confirmation code, causing the first user device to display a user interface configured to receive a confirmation code;
obtaining a confirmation code associated with the purchase, based on a first input by the first user received in the user interface;
transmitting, to a price monitoring server, a request for monitoring price information associated with the booked flight, the request comprising the confirmation code;
receiving, from the price monitoring server, price information associated with the booked flight, wherein:
the price information was extracted from an email in a second email account on a second user device, and
the email in the second account relates to the booked flight;
determining, based on the received price information, whether a condition for flight adjustment is met, the condition having been specified by a second input by the first users at the first user device; and
upon determining that the condition for flight adjustment is met, submitting, to an airline service provider, a request for adjusting the booked flight, the request comprising the confirmation code.

20. A non-transitory computer-readable medium storing instructions executable by a processor to perform a method for servicing a user's flight, the method comprising:
monitoring, using a background process, online activities associated with a first user that occur at a first user device associated with the first user;
identifying a transaction of the first user associated with the first user device according to the activities;
accessing a first email account on the first user device;
identifying, within the accessed first email account, an email relating to the transaction;
detecting a purchase, at the first user device at a first price, of an airline ticket for a booked flight, based on the identified email within the first email account;
determining whether the identified email within the first email account comprises a confirmation code associated with the booked flight, the confirmation code being a unique identifier of the airline ticket for the booked flight;
upon determining that the identified email within the first account does not comprise a confirmation code, causing the first user device to display a user interface configured to receive a confirmation code;
obtaining a confirmation code associated with the purchase, based on a first input by the first user received in the user interface;
transmitting, to a price monitoring server, a request for monitoring price information associated with the booked flight, the request for monitoring price information associated with the booked flight comprising the confirmation code;
receiving, from the price monitoring server, price information associated with the booked flight, wherein:
the price information was extracted from an email in a second email account on a second user device, and
the email in the second account relates to the booked flight;
determining, based on the received price information associated with the booked flight, whether a condition for flight adjustment is met, the condition having been specified by a second input by the first user at the first user device; and
upon determining that the condition is met, submitting, to an airline service provider, a request for adjusting the booked flight, the request comprising the confirmation code.
